(19) United States
(12) Patent Application Publication
(10) Pub. No.: US 2016/0111066 A1
(43) Pub. Date: Apr. 21, 2016

(54) SEGMENT DISPLAY DEVICE

(71) Applicant: Azbil Corporation, Tokyo (JP)

(72) Inventor: Hiroshi KOGA, Tokyo (JP)

(21) Appl. No.: 14/883,040

(22) Filed: Oct. 14, 2015

(30) Foreign Application Priority Data
Oct. 15, 2014 (JP) 2014-210509
Nov. 20, 2014 (JP) 2014-235268

(51) Int. Cl. G09G 5/34; G09G 3/04

(52) U.S. Cl. CPC G09G 5/343; G09G 3/04; G09G 2354/00; G09G 2340/0464

(57) ABSTRACT

A segment display device includes first and second operation input units; a segment display unit; a storage unit for storage by mapping information which can be displayed in the segment display unit in a display information table including a plurality of cells specified by a plurality of rows and columns; and a display control unit which displays information read from the storage unit to segment display unit; every time an operation is input to the first operation input unit, said display control unit selects information in each cell of the display information table in order in the first direction along the column in the display information table and is displayed; every time that an operation is input to the second operation input unit, information in each cell of the display information table is selected in order in the second direction along the row of the display information table.

### CROSS-REFERENCE TO RELATED APPLICATIONS

This application claims the benefit of and priority to each of Japanese Patent Application 2014-235268, filed on Nov. 20, 2014, and Japanese Patent Application No. 2014-210509, filed on Oct. 15, 2014, the entire contents of each of which are incorporated by reference herein.

### INDUSTRIAL FIELD

The present invention relates to a segment display device.

### BACKGROUND TECHNOLOGY

Formerly, when control devices which supervised and controlled equipment in plants, buildings and other facilities were used, segment displays which displayed information using a plurality of segments were used rather than liquid crystal displays due to costs and the long-term stable supply of components. For example, when data servers for building automation were used, operation status (activation and shut-down of applications, on-line and off-line status), the error codes as well as device addresses and a variety of other types of information were displayed using a segment display.

Conventional technology related to segment display devices is known to include a method (see Patent Document 1) in which the status of a trial-run of a hot water heating device is displayed on a 7-segment display device, and a method (see Patent Document 2) in which signal levels are displayed as a bar graph using a segment display device, and the like.

### PRIOR ART LITERATURE

### Patent Literature

[Patent Document 1] Japanese Patent Application Publication H11-51453
[Patent Document 2] Japanese Patent Application Publication 2002-6788

### OVERVIEW OF INVENTION

### Problems Which the Present Invention is Intended to Solve

However, conventional segment display devices could hardly be called user-friendly interfaces. For example, it was necessary to increase the number of display digits to increase the amount of information displayed in the segment display device. However, since there were restrictions on the cost and the space used to set up the segment display unit, increasing the number of display digits was no simple matter. In addition, an operation button used to switch the information displayed had to be set up on the segment display device. However, due to restrictions on the cost as well as on the space available to set up the operation button it was impossible to dispose many operation buttons. As a result, when the conventional segment display device was used, complex operations such as pushing the operation button for a long period of time and simultaneous pressing of a plurality of operation buttons were required in order to switch a plurality of different types of information using a restricted number of display digits, and operating errors readily occurred.

In addition, when a segment display device with few display digits was used, when a plurality of items were to be displayed by switching the items, there were problems in that it was difficult to understand the relation between the operations of the operation button and the display results.

In order to resolve the above-mentioned problems, it is an object of the present invention to make it easy for the user to understand the information, selected from various types of information, using a segment display device.

### Means Used to Solve the Problems

The segment display device (1,5) in the present invention is provided with a first operation input unit (12) and a second operation input unit (13) used to input operations from outside; a segment display unit (10) used to display information in a segment format; a storage unit (16) used to store information which can be displayed on said segment display unit by mapping in a display information table (160) made up of a plurality of cells specified by a plurality of columns and rows; and a display control unit (17) which reads information mapped in said cells from said storage unit and displays it in said segment display unit. Every time an operation is input to said first operation input unit, said display control unit selects information mapped in each cell of said display information table in order in the first direction (+Y) along a column in said display information table and displays it to said segment display unit; at the same time, when an operation is input to said second operation input unit, information mapped in each cell in said display information table is selected in order in the second direction (+X) along a row in said display information table and is displayed in said segment display unit.

In the above-mentioned segment display device, when an operation is input to said first operation input unit, said segment display unit scrolls the information displayed at that time, segment by segment, in a direction opposite the direction indicated by said first operation unit. At the same time, the information to be displayed next is displayed by scrolling, segment by segment, in the direction opposite that indicated by said first operation input unit so that the information to be display may be switched.

In the above-mentioned segment display device, said segment display unit has a display area with plurality of digits which displays information in segment format. When an operation is input to said second operation input unit, it is acceptable to switch the information to be displayed by causing said segment display unit to scroll information to be displayed one digit at a time in the direction opposite the direction indicated by said second operation input unit; at the same time the information to be displayed next is scrolled one digit at a time in a direction opposite the direction indicated by said second operation input unit and displayed.

With said segment display device, at the time information mapped in a cell corresponding to the last row in said first direction in a single column in said display information table is displayed, when an operation is input to said first operation input unit, it is acceptable for said display control unit to display, in said segment display unit, the information mapped in a cell corresponding to the first row in said column

With said segment display device, at the time that said display control unit displays information mapped to a cell, from among the cells mapped for the information, that corresponds to the last row in said second direction of a single row in said display information table, when an operation is input to said second operation input unit, it is acceptable to display in said segment display unit the information mapped in a cell corresponding to the first column in said second direction in said row..

The above-mentioned segment display device (5) is also provided with a third operation input unit (14) and a fourth operation input unit (15) used to input the operation from outside; every time an operation is input to said third operation input unit, said display control unit selects information mapped in each cell of said display information table in order in the direction (−Y) opposite the first direction of said display information table and displays it in said segment display unit. At the same time, every time an operation is input to said fourth operation input unit, information mapped in each cell in said display information table is selected in order in the direction (−X) opposite said second direction in said display information table and may be displayed on said segment display unit.

In the above-mentioned segment display device, when an operation is input to said third operation input unit, said segment display unit scrolls the information displayed at that time segment by segment in the direction opposite the direction indicated by said third operation input unit. At the same time, the information to be displayed next is displayed by scrolling one segment at a time in the direction opposite the direction indicated by said third operation input unit so that the information to be displayed may be switched.

In the above-mentioned segment display device, said segment display unit has a display area with a plurality of digits which displays the information in a segment format. When an operation is input to said fourth operation input unit, said segment display unit scrolls one digit at a time the information to be displayed in a direction opposite the direction indicated by said fourth operation input unit. At the same time, the information to be displayed next is displayed by scrolling one digit at a time in a direction opposite the direction indicated by said fourth operation input unit so that the information to be displayed can be switched.

The purpose of the reference numerals in brackets in the above-mentioned explanation is merely to illustrate the concept of constituent elements to which said reference numerals are attached in the figures.

### Effect of Invention

As explained above, the present invention makes it easy for the user to understand the information selected from the plurality of types of information in the segment display device.

### BRIEF EXPLANATION OF FIGURES

FIG. 1 is a diagram illustrating the data server provided with the segment display device in an embodiment of the invention.

FIG. 2 is a diagram illustrating an example of the exterior of the segment display device in Embodiment 1 of the invention.

FIG. 3 is a diagram illustrating an example of the inside configuration of the segment display device in Embodiment 1 of the invention.

FIG. 4 is a diagram illustrating an example of the display information table stored in the segment display device in Embodiment 1 of the invention.

FIG. 5A is a diagram of a specific example of the procedure involved in switching the display of information using the segment display device in Embodiment 1 of the invention.

FIG. 5B is a diagram illustrating another specific example of the procedure involved in switching the display of information using the segment display device in Embodiment 1 of the invention.

FIG. 6 is a diagram of an example of allocating an address for each type of data in the display information table.

FIG. 7A is a diagram illustrating an example of the scroll display of the displayed information when switching from display state t1 to display state t2 in FIG. 5A.

FIG. 7B is a diagram illustrating an example of the scroll display of display information when switching from display state t2 to display state t3 in FIG. 5A.

FIG. 8 is a diagram illustrating the data space imaged by segment display device in Embodiment 1 of the invention.

FIG. 9 is a diagram illustrating an example of the exterior of the segment display device in Embodiment 2 of the invention.

FIG. 10 is a diagram illustrating the inside configuration of the segment display device in Embodiment 2 of the invention.

FIG. 11 is a diagram explaining the method of displaying information using the display information table using the segment display device in Embodiment 2 of the invention.

FIG. 12 is a diagram illustrating another example of switching the display of information using the segment display device in Embodiment 2 of the invention.

FIG. 13A is a diagram illustrating an example of the scroll display of display information when switching from display state t1 to display state t2 in FIG. 12.

FIG. 13B is a diagram illustrating an example of the scroll display of display information when switching from display state t3 to display state t4 in FIG. 12.

FIG. 14 is a diagram illustrating another specific example of the procedure of switching the display of information using the segment display device in the present invention.

### EMBODIMENT OF THE INVENTION

Next, we shall describe embodiments of the present invention referring to the figures.

### Embodiment 1

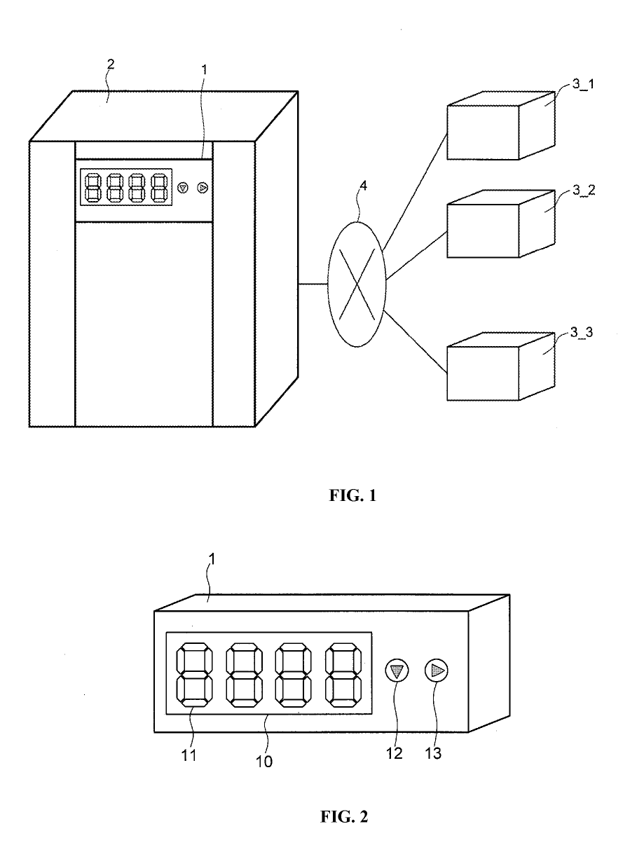

FIG. 1 is a diagram illustrating a data server provided with the segment display device in one embodiment of the present invention.

Data server 2, which is indicated in the same diagram, is a server used, for example, for building automation and is connected to a plurality of controllers 3_1 to 3_3 used to control the devices comprising the air-conditioning equipment and sensors among others via a network 4. Specifically, data server 2 monitors via controllers 3_1 to 3_3 the devices and sensors connected to each of the controllers 3_1 to 3_3, obtains a variety of information to be monitored and accumulates it.

Furthermore, three controllers, namely, controllers 3_1 to 3_3 are illustrated in FIG. 1, however, there are no particular restrictions on the number of controllers connected to data server 2.

Data server 2 is provided with the above-mentioned segment device 1 and can display its own operation status (such as activation and stopping of applications, on-line, off-line and the like), error codes and device addresses and other types of information using segment device 1. In addition, controllers 3_1 to 3_n are also provided with segment device 1 and each type of information can be displayed.

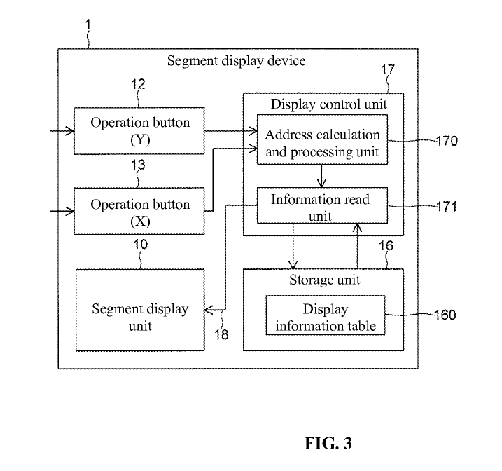

FIG. 2 is an example of the exterior of the segment display device in the embodiment of the present invention.

Segment display device 1 indicated in the same diagram is provided with segment display unit 10 provided with display area 11 used to display alphanumeric and other characters in the segment format; and operation buttons 12, 13 used as operation input units which receive operations from the outside.

Segment display device 1 displays the required information on segment display unit 10 when the user presses operation buttons 12, 13. Next, we shall describe a specific configuration of segment display device 1.

FIG. 3 is a diagram of the internal configuration of the segment display device in Embodiment 1 of the invention.

As indicated in FIG. 3, segment display device 1 is provided with segment display unit 10, operation buttons 12, 13, storage unit 16 and display control unit 17.

Operation buttons 12, 13 are used to detect when the user presses down and output operation detection signals. Operation buttons 12, 13 handle respectively the Y, X coordinates of the data spaces of display information table 160, which will be discussed below. For example, operation button 12 handles the Y direction (direction of columns) as the first direction of the data spaces in display information table 160; and operation button 13 handles the X direction (direction of rows) as the second direction of the data spaces of display information table 160.

The details will be discussed further on, however, information displayed on segment display unit 10 (to be discussed further on) is switched when operation buttons 12, 13 are pressed down.

Segment display unit 10 is provided with a plurality of digits for display area 11 which is made up of a plurality of segments; and display information 18 provided from display control unit 17 is displayed in a plurality of display areas 11. Each segment making up display area 11 is configured, for example, of an LED and fluorescent display tube, liquid crystal and the like.

Furthermore, as shown in FIG. 2, in the embodiment we shall explain an example wherein segment display unit 10 is provided with a display area 11 consisting of 4 digits and a single display area 11 is made up of 7 segments. However there are no particular restrictions on the number of display digits in segment display unit 10 and the number of segments in display area 11.

Storage unit 16 may be configured of EEPROM (Electrically Erasable Programmable Read-Only Memory) as well as flash memory and other data writable nonvolatile memory units as well as RAM (Random Access Memory). Storage unit 16 stores a variety of information which can be displayed on segment display unit 10 and also stores control programs executed by display control unit 17.

Here, the various types of information which can be displayed on segment display unit 10 may be information on the operating status, information on error codes, information on device addresses and the like, as was discussed above.

Specifically storage unit 16 stores a variety of types of information which can be displayed on the above-mentioned segment display unit 10 by mapping in a display information table (data space) 160 made up of a plurality of columns and rows.

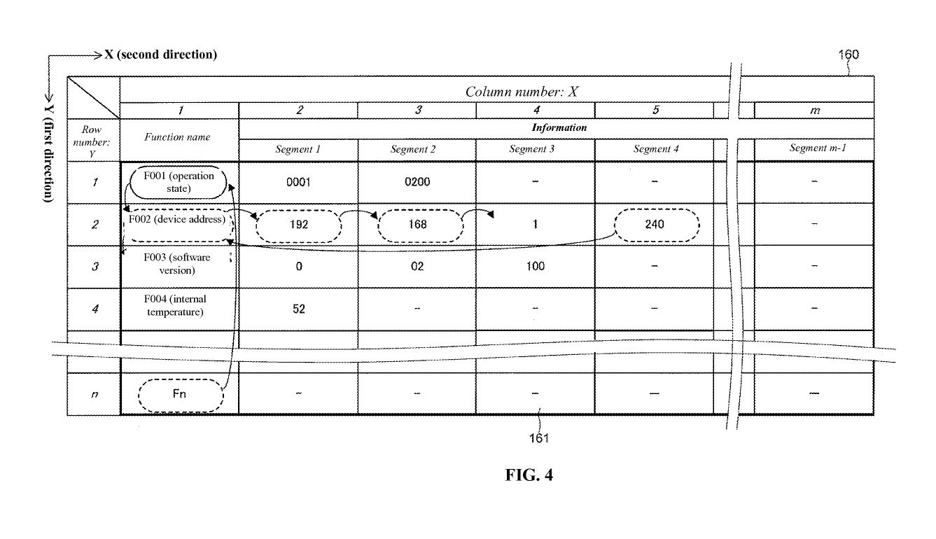

FIG. 4 is a diagram illustrating an example of the display information table stored in the segment display device in Embodiment 1 of the invention. Furthermore, the same diagram illustrates an example of display information table 160 consisting of n rows and m column to display on segment display device 1, the operation status among others of data server 2 when segment display device 1 is applied to data server 2. Here, both m, n are integers of 2 or more.

As illustrated in FIG. 4, display information table 160 is provided with a plurality of cells 161 specified by row number Y and column number X and information to be displayed on segment display unit 10 is allocated to the various cells 161. For example, in FIG. 4, information on “function name” which indicates the type of function to be displayed is allocated to each cell specified by row number Y=1˜n in column number X=1. For example, in FIG. 4, the operation state of data server 2, device address, software version and internal temperature are respectively allocated to function name information “F001˜F004.” In addition, specific information on each of the function names is allocated to each cell 161 specified by column number X=2˜m and row number Y=1˜n.

For example, function name “F001 (operation state of data server 2)” is allocated to cell (X,Y)=(1,1) and concrete information “0001-0200” which indicates the operating state of data server 2 is allocated to (X,Y)=(2,1)˜(m, 1). In addition, function name “F002 (device address of data server 2)” is allocated to cell (X,Y)=(1,2) and information “192.168.1.240” indicating the device address of data server 2 is allocated to (X,Y)=(2,2)˜(m,2).

As indicated above, concrete information relating to each of the function names (F001˜Fn) is allocated to each of cells (X,Y)=(2,1)˜(m,n).

For example, when the number of characters to be displayed in segment display unit 10 exceeds the number of digits displayed in segment display unit 10, that information is separated (split) into multiple pieces of information, and the separated information should be allocated respectively to each of cells (X,Y)=(2,1)˜(m,n). For example, as indicated in FIG. 2, when segment information unit 10 is provided with a display area 11 consisting of 4 digits and when information indicating the operation state of data server 2 is “0001-0200,” said information is split into “0001” and “0002,” and the two pieces of information split are allocated respectively to cell (X,Y)=(2,1) and cell (X,Y)=(3,1), as indicated in FIG. 4.

In addition, when information to be displayed in segment display unit 10 is configured of a plurality of clusters of information, the information should be split taking into consideration the various clusters of information and the maximum number of digits displayed and may be allocated to each cell. For example, as indicated in FIG. 4, when information indicating “F002 (device address of data server 2) is “192.168.1.240,” as indicated in FIG. 4, said information is split into four pieces of information “192,” “168,” “1” and “240” and the information split should be allocated respectively into cells (X,Y)=(2,2), (3,2), (4,2) and (5,2).

Display control unit 17 displays on segment display unit 10 information in display information table 160 stored in storage unit 16 by selecting in sequence of the Y direction or the X direction in accordance with the operation detection signals from operation buttons 12, 13.

Specifically, display control unit 17 selects information mapped in each cell in display information table 160 every time an operation is input to operation button 12 in the column direction (Y direction) of display information table 160 in sequence and provides it to segment display unit 10. More specifically, every time operation button 12 is pressed, display control unit 17 selects a cell located after moving the equivalent of one cell in the +Y direction from a cell in display information table 160 displayed at this time, and the information allocated to said cell is displayed on segment display unit 10.

In addition, every time an operation is input to operation button 13, display control unit 17 selects information mapped in each of the cells in display information table 160 in the row direction (X direction) of display information table 160 and provides it to segment display unit 10. More specifically, every time operation button 13 is pressed, display control unit 17 selects the cell located after moving the equivalent of one cell in the +X direction from a cell in display information table 160 displayed at that time and information allocated to said cell is displayed to segment display unit 10.

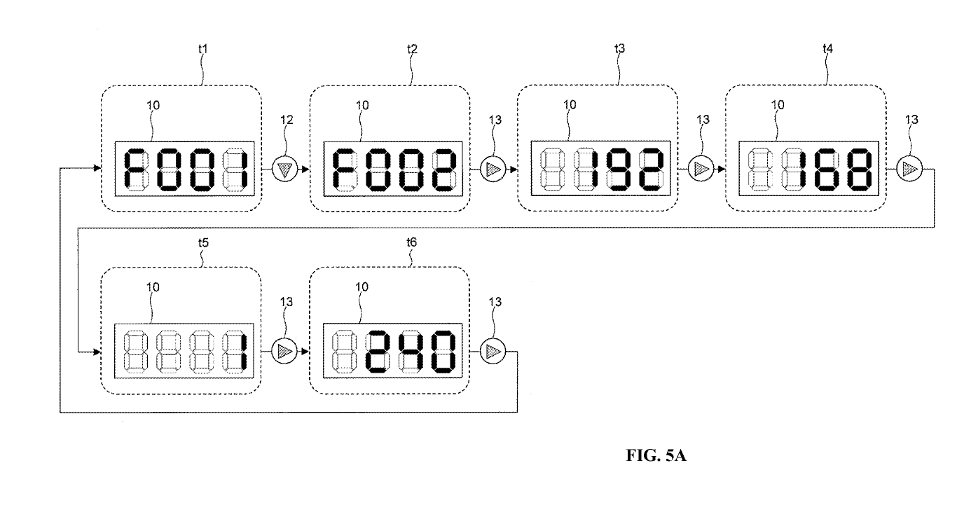

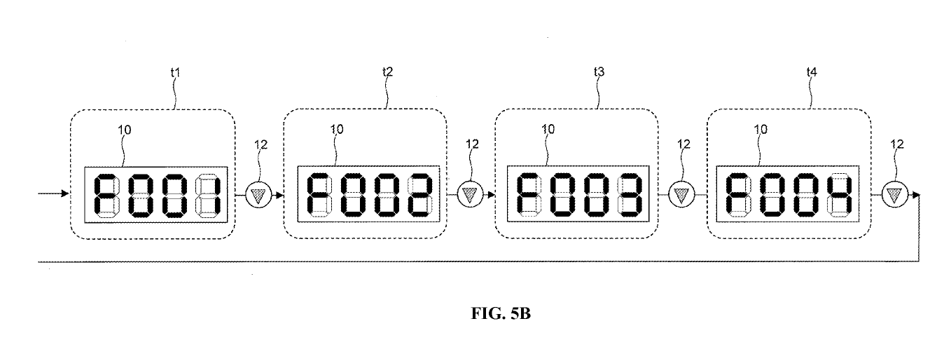

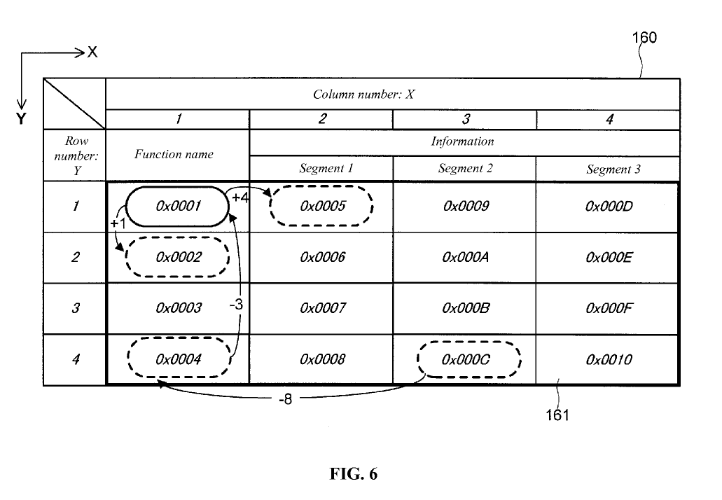

FIGS. 5A and FIG. 5B are concrete examples of the switching procedure for displaying information using the segment display device in Embodiment 1. Furthermore, to facilitate explanation, FIGS. 5A and 5B illustrate examples when display information table 160 indicated in FIG. 4 consists of 4 rows x 5 columns (n=4, m=5).

Here, the example takes into consideration cell (X,Y)=(1,1) in display information table 160 indicated in FIG. 4, which is initialized as the initial display information in segment display unit 10.

As indicated in FIG. 5A, in the initial display state, that is, in display state t1 where the “F001” information in cell (X,Y)=(1,1) is displayed in segment display unit 10, when operation button 12 (Y direction) is pressed, display control unit 17 reads “F002” information allocated to cell (X,Y)=(1,2) from display information table 160, and it is displayed in segment display unit 10 (display state t2).

In display state t2, when operation button 13 (+X direction) is pressed, display control unit 17 reads information “192” allocated to cell (X,Y)=(2,2) from display information table 160, and it is displayed to segment display unit 10 (display state t3). Furthermore, in display state t3, when operation button 13 is pressed, display control unit 17 reads the information “168” allocated to cell (X,Y)=(3,2) from display information table 160, and it is displayed to segment display unit 10. Thereafter, likewise, each time operation button 13 is pressed, the information allocated in a cell located after moving one cell at a time in the X direction on display information table 160 as indicated by reference numerals t4, t5, t6 is selected and displayed to segment display unit 10.

In a state where information in the last segment in “F002 (device address in data server 2),” that is, information “240” which is allocated to cell (X,Y)=(5,2), is displayed in segment display unit 10, when operation button 13 is again pressed, display control unit 17 again returns to cell (X,Y)=(1,2), and information “F002” in said cell is again displayed (display state t1).

In addition, as indicated in FIG. 5B, in display state t2, which displays “F002” information allocated to cell (X,Y)=(1,2) in segment display unit 10, when operation button 12 (Y direction) is pressed, display control unit 17 reads “F003” information allocated to cell (X,Y)=(1,3) from display information table 160 and displays it to segment display unit 10 (display state t3). Furthermore, in display state t3 indicated in FIG. 5B, when operation button 12 is pressed, display control unit 17 reads “F004” information allocated to cell (X,Y)=(1,4) from display information table 160 and displays it to segment display unit 10. Thereafter, likewise, every time operation button 12 is pressed, the information allocated in a cell located after moving one cell in display information table 160 in the Y direction is selected and displayed to segment display unit 10.

Then, in a state where information for last row number Y=n in column number X=1 is displayed, when operation button 12 is pressed, display control unit 17 again returns to the initial display state. For example, as indicated in FIG. 5B, when operation button 12 is pressed, in display state t4 which displays information “F004” in cell (X, Y)=(1,4), one returns to cell (X,Y)=(1,1) and information “F001” allocated to said cell is displayed.

As indicated in FIG. 3, control of switching of display information in accordance with the above-mentioned operation buttons 12, 13 is realized by display control unit 17 functioning as address calculation and processing unit 170 and information read unit 171. For example, display control unit 17 is a CPU or other program processing device. Processing is carried out by processing in accordance with the above-mentioned information control program stored in storage unit 160 so that display control unit 17 functions as address calculating and processing unit 170 and information read unit 171.

Address calculation and processing unit 170 generates address information based on the operation detection signals outputted from operation buttons 12, 13. Here, address information is information on a memory address which specifies a storage area in storage unit 16. Information read unit 171 inputs address information generated by address calculation and processing unit 170, reads information (data) stored in a memory address specified by input address information from storage unit 16, and provides it to segment display unit 10 as display information 18.

Next, we shall provide a detailed explanation of the method of generating address information using address calculation and processing unit 170. FIG. 6 is a diagram of an example of address allocation in display information table 160. In the same figure, 4 rows×4 columns display information table 160 (m=n=4) is indicated as an example.

Each cell 161 in display information table 160 in FIG. 6 is allocated respectively to a storage area specified by a memory address in storage unit 16. For example, as indicated in FIG. 6, cell (X,Y)=(1,1) is coordinated to a storage area specified by memory address “0x0001”; cell (X,Y)=(1,2) is coordinated to a storage area specified by memory address “0x0002”; cell (X,Y)=(1,3) is coordinated to a storage area specified by memory address “0x0003”; cell (X,Y)=(1,4) is coordinated to a storage area specified by memory address “0x0001”). Likewise, cells (X,Y)=(2,1)˜(2,4) are coordinated to storage areas specified by memory addresses “0x0005˜“0x0008”; cells (X,Y)=(3,1)˜(3,4) are coordinated to storage areas specified by memory addresses “0x0009”˜“0x000C”; cells (X,Y)=(4,1)˜(4,4) are coordinated to storage areas specified by memory addresses “0x000D”˜“0x0010.”

Next, we shall describe the procedures for generating address information. For example, when a reset of segment display device 1 is cancelled, first of all, address calculation and processing unit 170 makes a setting for an initial value in a designation address which designates display information displayed in segment display unit 10. For example, the designation address is set to a memory address “0x0001” corresponding to (X,Y)=(1,1).

After initialization has been carried out, every time operation button 12 (Y direction) is pressed, address calculation and processing unit 170 successively adds “+1” to the value of the designated address so that the designated addresses are successively updated. For example, first of all, every time operation button 12 is pressed in the initial state, address calculation and processing unit 170 adds “+1” to address initial value “0x0001,” and the designated address “0x0002” is generated and is provided to information read unit 171. Then, when operation button 12 is again pressed, address calculation and processing unit 170 adds “+1” to address “0x0002,” and the designated address “0x0003” is generated and is provided to information read unit 171. Thereafter, in the same way, every time operation button 12 is pressed, “+1” is added to the address at that time so that the designated address is updated and is provided to information read unit 171. Every time a memory address provided by address calculation and processing unit 170 is updated, information read unit 171 successively reads information designated by said memory address from storage unit 16 and the information is provided to segment display unit 10.

In addition, when operation button 12 is pressed in a state where information in a cell on the last row in a single column in display information table 160 is displayed in segment display unit 10, address calculation and processing unit 170 generates a designated address corresponding to a cell in the first row in said column. For example, when operation button 12 is pressed after a designated address is generated for a cell in the last row in a single column in the display information table 160, address calculation and processing unit 170 adds “−{(last row number)−1}” to the designated address at this time so that the designated address is generated and is provided to information read unit 171. For example, as indicated in FIG. 6, after the designated address “0x0004” for a cell in the last row in column X=1 in display information table 160 is generated, when operation button 12 is pressed, address calculation and processing unit 170 adds “−3(=−(4-1))” to “0x0004” so that designated address “0x0001” is generated and is provided to information read unit 171.

As indicated above, by updating the designated address in storage unit 16 in accordance with the operation input to operation button 12, the information in each cell in a single column can be displayed on segment display unit 10 in sequence in accordance with the row number.

Meanwhile, after initialization has been carried out, every time operation button 13 is pressed, address calculation and processing unit 170 successively adds “+4” to the value of a designated address so that the designated address is updated successively. For example, when operation button 13 is pressed in the initial state, address calculation and processing unit 170 adds “+4” to the initial value “0x0001” of the address, and designated address “0x 0005” is generated and is provided to information read unit 171. Then, when operation button 13 is further pressed, address calculation and processing unit 170 adds “+4” to address “0x 0005,” and designated address “0x0009” is generated and provided to information read unit 171. Then, likewise, every time operation button 13 is pressed, “+4” is added to the address at that time so that the designated address is updated and provided to information read unit 171.

In addition, when operation button 13 is pressed in a state where information mapped in the last cell in the X direction in cells where information in one row of display information table 160 is mapped is displayed, address calculation and processing unit 170 generates the designated address corresponding to a cell in the first column in said row. For example, let us consider the case in which information is allocated to a cell in the 1^{st} through 3^{rd} column (X=1˜3) in a cell in the fourth row (Y=4) and information in cell (X,Y)=(3,4) is displayed in segment display unit 10. In this case, the latest designated address generated in address calculation and processing unit 170 is “0x000C.” In this state, when operation button 13 is pressed, address calculation and processing unit 170 adds “−4×{(column number of cell allocated for information)−1}” is added to designated address “0x000C” so that the designated address is generated and provided to information read unit 171. More specifically, in the case above, information is allocated up to cell (X=3) in the third column of a cell in the fourth row (Y=4) and therefore, by adding “−8(=−4×(3-1))” to “0x000C,” the designated address “0x0004” is generated and provided to information read unit 171.

For example, in the case indicated in FIG. 4 above, when operation button 13 is pressed in the state where the last information “100” indicating “software version (F003),” that is, information for (address: 0x000F) in the cell (X,Y)=(4,3) is displayed, address calculation and processing unit 170 adds “−12(=−4x (4-1))” to address “0 x000F” and designated address “0x 0003” is generated and provided to information read unit 171 so that information “F003” in cell (X,Y)=(1,3) is displayed to segment display unit 10.

As indicated above, a designated address in storage unit 16 is updated in accordance with the operation input to operation button 13, so that information in each of the cells for which information in a single row has been allocated, can be displayed on segment display unit 10 in the sequence according to the column number.

In the explanation given above, segment display device 1 in Embodiment 1 of the invention illustrates a case in which information displayed is rapidly switched in keeping with the operation input to operation buttons 12, 13. However, it is by no means restricted to this, and the information to be displayed may be switched by scrolling the display information in keeping with the operation input to operation buttons 12, 13. Next, we shall provide a detailed explanation of the above-mentioned scrolling display using the example indicated in FIG. 5A.

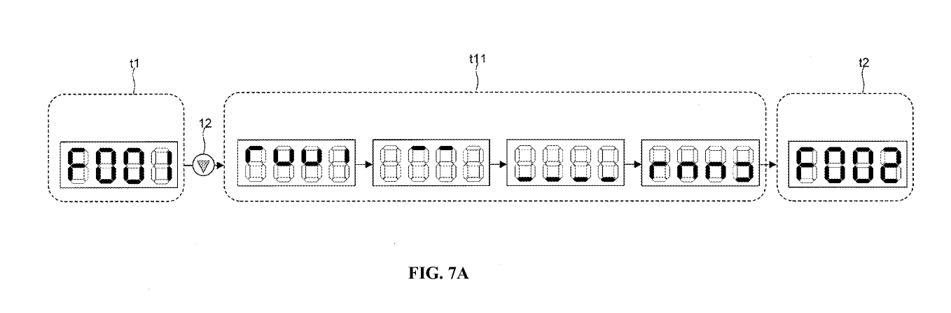

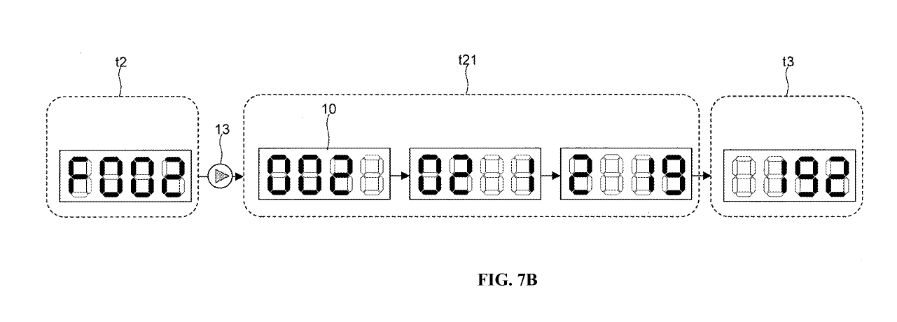

FIG. 7A is a diagram of an example of the scroll display of display information when switching is carried out from display state t1 in FIG. 5A to display state t2. FIG. 7B is a diagram illustrating an example of scroll display of display information when switching from display state t2 in FIG. 5A to display state t3.

First, when operation button 12 (+Y direction) is pressed in display state t1, which indicates information “F001,” display control unit 17 reads information “F002” allocated to cell (X,Y)=(1,2) from display information table 160 and displays it on segment display unit 10. At this time, segment display unit 10 scrolls segment by segment “F001” information displayed in display state t1 in the direction (upward direction when segment display unit 10 in FIG. 2 is seen from the front) opposite the direction indicated by operation button 12 in FIG. 2. At the same time, the next information “F002” is scrolled in the upward direction mentioned above and is displayed, segment by segment, as indicated in display state t11 in FIG. 7A.

Next, when operation button 13 (+X direction) is pressed again in display state t2, which displays information “F002,” display control unit 17 reads information “192” allocated to cell (X,Y)=(2,2) from display information table 160 and displays it to segment display unit 10. At this time, as indicated in display state t21, segment display unit 10 scrolls one digit at a time, in display area 11, and information “F002,” which is displayed in display state t2 in the direction (left direction when segment display unit 10 in FIG. 2 is seen from the front) opposite the direction indicated by operation button 13 in FIG. 2. At the same time, the next information “192” is scrolled one digit at a time in display area 11 in the left direction indicated above and is displayed. Furthermore, the displayed information is scrolled as well as the case even when a switch was made to display states t4, t5, t6 and t1 in FIG. 5A.

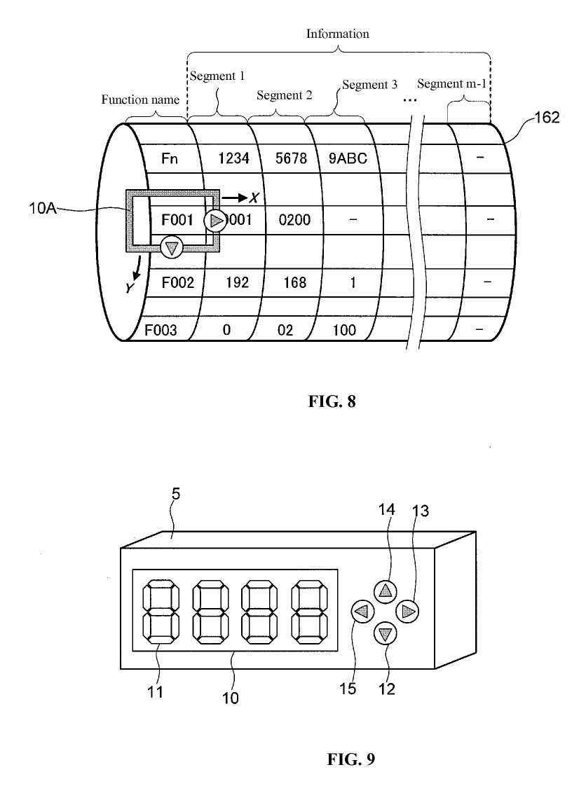

We saw above how when the segment display device in the present invention is used, information in the display information table is selected in sequence in the row direction and the column direction of the display information table in accordance with the operation input to the operation buttons and displayed in segments so that the information selected from the various pieces of information can be presented to be understood by the user easily. Specifically, by use of this segment display device, there is ability to present to the user a likeness wherein segment display unit 10, acting as a viewing window, as shown in FIG. 8, moves over data space 162 (constituted of display information table 160) in the X direction (row direction) and the Y direction (column direction), and this allows the user to easily obtain the desired information from among many pieces of information, while operation buttons are few and the information amount in the form of segment display is small..

In addition, when displayed information is switched according to the operation input to operation buttons 12, 13, displayed information is scrolled and switched as indicated above so that an image which moves in the direction of operation buttons 12, 13 (X direction and Y direction) seen by eyehole 10A in the above-mentioned data space 162 can be clearly grasped by a user so that the user can obtain the desired information more easily.

### Embodiment 2

FIG. 9 is a diagram of an example of the exterior of the segment display device in Embodiment 2.

Segment display device 5 indicated in the figure is different from the segment display device 1 in Embodiment 1 of the invention in that it has two more operation input units and it is the same as segment display device 1 in all other respects. Furthermore, in segment display device 5 in Embodiment 2, the reference numerals used for the constituent elements are the same as in segment display device 1 in Embodiment 1 so that we shall not repeat the explanation.

As illustrated in FIG. 9, segment display device 5 is further provided with operation buttons 14, 15 as operating input units. Like operation buttons 12, 13, operation buttons 14, 15 detect input for pressing down operations from the outside (user) and outputs operation detection signals. Operation button 14 associates to the column direction (Y direction) of the data space of display information table 160 and handles the direction (−Y direction) that is opposite the direction handled by operation button 12 (+Y direction). In addition, operation button 15 associates to the row direction (X direction) of display information table 160 and handles the direction (-X direction) that is opposite the direction handled by operation button 13 (+X direction). Like operation buttons 12, 13, information on display information table 160 is switched to the Y direction or X direction by pressing down on operation buttons 14, 15 and the display operation to display in segment display unit 10 is controlled by switching one cell at a time.

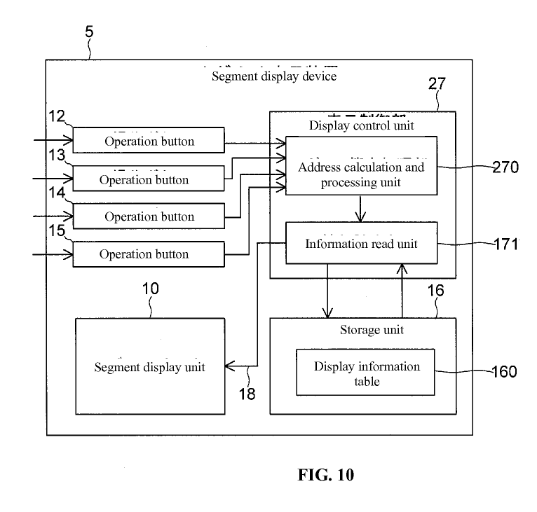

FIG. 10 is a diagram illustrating the internal constituents of segment display device 5 in Embodiment 2.

As illustrated in this figure, like display control unit 17, display control unit 27 reads the desired information from display information table 160 in storage unit 16 in accordance with operation detection signals from operation buttons 12-15 and provides it to the segment display unit 10 as displayed information 18.

Specifically, every time an operation is input to operation button 12, display control unit 27 selects information mapped to each of the cells in display information table 160 in order in the +Y direction of display information table 160 and provides it to segment display unit 10; every time an operation is input to operation button 14, information mapped in each cell in display information table 160 is selected in sequence in the −Y direction of display information table 160 and is provided to segment display unit 10.

In addition, every time an operation is input to operation button 13, display control unit 27 selects information mapped in each cell in display information table 160 in sequence in the +X direction of display information table 160 and provides it to segment display unit 10. Every time an operation is input to operation button 15, information mapped to each of the cells in display information table 160 is selected in sequence in the −X direction of display information table 160 and is provided to segment display unit 10.

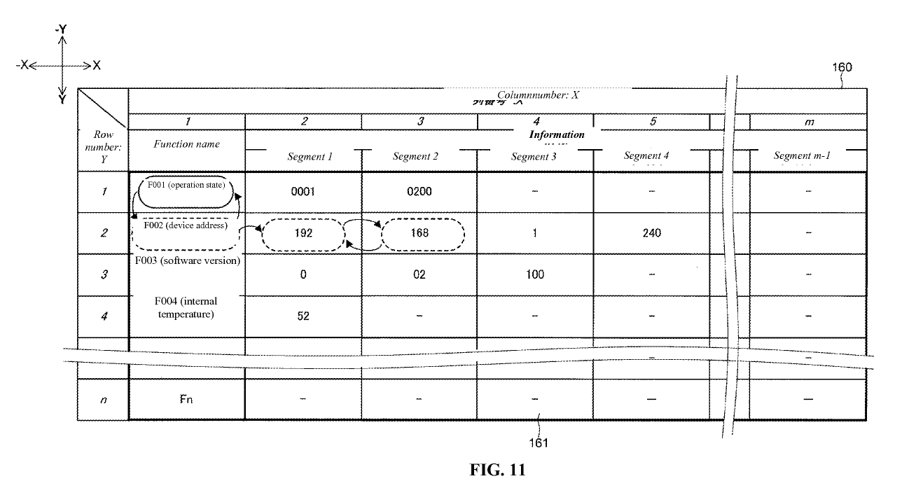

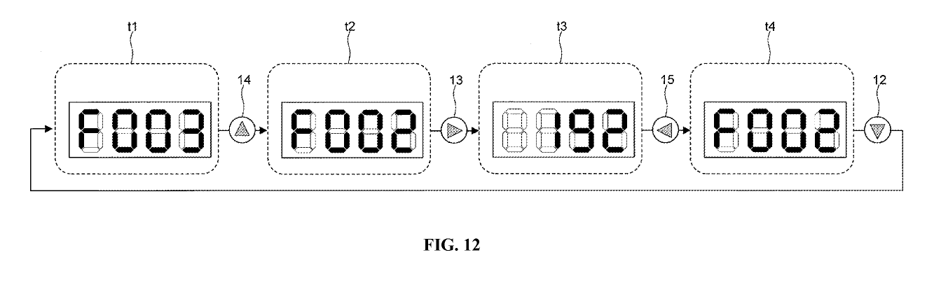

FIG. 11 is a diagram which explains the procedures for switching the display information using the operation input unit in the segment display device in Embodiment 2.

As illustrated in FIG. 11, when operation button 12 is pressed in a state where, for example, (X,Y)=(1,1) is set as the initial value of a cell displayed in segment display unit 10, display control unit 27, like display control unit 17, selects information in the first column (X =1) from the first row (Y=1) to the nth row (Y=n) in sequence in the +Y direction and displays it to segment display unit 10. For example, every time operation button 12 is pressed, information in the first row (function name) is selected in the following order: “F001,” “F002,” “F003,” . . . , “Fn,” and displayed.

Meanwhile, every time operation button 14 is pressed in a state where (X,Y)=(1,1) is selected as an initial value for the cell, display control unit 27 selects information in the first column (X=1)from the first row up to the nth row, in sequence in the −Y direction and displays it to segment display unit 10. For example, every time operation button 14 is pressed, information in the first column (identifying information) is selected in the following order: “Fn,” . . . , “F003,” “F002,” “F0001” and is displayed.

In addition, for example, every time operation button 13 is pressed in a state where (X,Y)=(1,1) is set as the initial value of a cell displayed in segment display unit 10, display control unit 27, like display control unit 17, selects information in the first row (Y=1) from the first column (X=1) up to the mth column (X=m) in order along the +X direction and displays it to segment display unit 10. For example, when operation button 13 is pressed, information in the first row is selected in the following order: “0001,” “0200,” “F001 ,” “0001,” “0200,” . . . and is displayed.

Meanwhile, when operation button 15 is pressed in a state where (X,Y)=(1,1) is set as the initial value of a cell, display control unit 27 selects information in the first row (Y=1) from the first column (X=1) to the mth column (X=m) in order in the −X direction and displays in segment display unit 10. For example, when operation button 15 is pressed, information in the first row is selected in the following order: “0200,” “0001,” “F001,” “0200,” “0001” . . . and displayed.

Display control unit 27 is configured of address calculation and processing unit 270 and information read unit 171. Address calculation and processing unit 270, like address calculation and processing unit 170, generates address information based on operation detection signals provided by operation buttons 12 through 15. Specifically, every time operation button 12 is pressed, address calculation and processing unit 270 adds successively “+1” to the value of the designated address and successively updates it. At the same time, when operation button 14 is pressed, “−1” is added successively to the value of the designated address and the designated address is successively updated.

Also, every time operation button 14 is pressed in a state where information in a cell in the first row in a single column in display information table 160 is displayed in segment display unit 10, address calculation and processing unit 270 generates the designated address corresponding to the cell in the last row of said column. For example, when operation button 14 is pressed after the designated address in a cell in the first row in a single column in display information table 160 is generated, address calculation and processing unit 270 adds “+{(final row number)−1}” to the designated address at that time so that the designated address is generated and is provided to information read unit 171. For example, as indicated in FIG. 6, when operation button 14 is pressed in a state which displays information for designated address “0x0001” in a cell in the first row in column X=1 in display information table 160, address calculation and processing unit 270 adds “+3(=+(4-1))” to “0x0001” so that designated address “0x0004” is generated and is provided to information read unit 171.

Furthermore, every time operation button 13 is pressed, as was the case for address calculation and processing unit 170, address calculation and processing unit 270 successively adds “+4” to the value of a designated address and the designated address is updated. At the same time, “−4” is successively added to the value of the designated address every time operation button 15 is pressed and the designated address is successively updated.

In addition, when operation button 15 is pressed in a state where information mapped in the first cell in the X direction of cells where information is mapped in one row in display information table 160 is displayed, address calculation and processing unit 270 generates the designated address corresponding to the cell of the last column in which information in said row is allocated. For example, in FIG. 6 discussed above, when information is allocated up to the cell in the third column (X=3) in each cell in the fourth row (Y=4), when operation button 15 is pressed in a state where information in a cell (address: 0x0004) in (X,Y)=(1,4) is displayed, address calculation and processing unit 270 adds “+4x {(column number of cell where information is allocated)−1}” to said designated address “0x0004” so that the designated address is generated and provided to information read unit 171. More specifically, in the above case, designated address “0x000C” is generated by adding “+8(=+4x(3-1)) to “0x0004” and is provided to information read unit 171.

In the explanation provided above, an example is shown in which segment display device 5 in Embodiment 2 of the invention switches displayed information quickly in keeping with the operation input to operation buttons 12 through 15. However, it is by no means restricted to this and the information to be displayed may be switched by scrolling the display information in accordance with the operation input to operation buttons 12 through 15. Next, we shall explain this in detail.

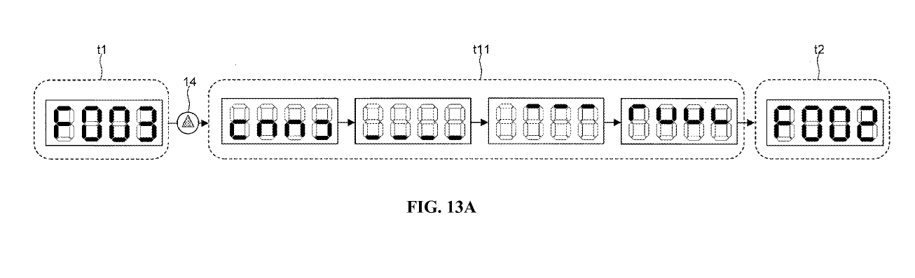

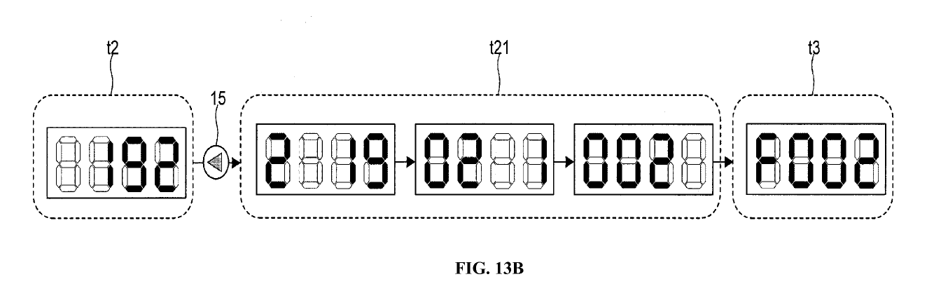

FIG. 12 is a diagram illustrating another specific example of the procedure for switching the display of information using the segment display device in Embodiment 2 of the invention. FIG. 13A is an example of a scrolling display of the display information in switching from display state t1 to display state t2 in FIG. 12. FIG. 13B is a diagram illustrating an example of a scrolling display of the display information when switching from display state t3 to display state t4 in FIG. 12.

When operation button 14 (−Y direction) is pressed in display state t1 which displays information “F003” in FIG. 12, display control unit 27 reads information “F002” allocated to cell (X,Y)=(1,2) from display information table 160 and displays it to segment display unit 10. At this time, segment display unit 10 scrolls information “F003” displayed in display state t1 segment by segment in the direction (bottom direction when segment display unit 10 in FIG. 2 is seen from the front) opposite the direction indicated by operation button 14 in FIG. 2, as indicated in display state t11 in FIG. 13A. At the same time, the following information “F002” is scrolled segment by segment in the above-mentioned bottom direction and is displayed.

Next, when operation button 13 (+X direction) is again pressed in display state t2, which displays information “F002” in FIG. 12, segment display unit 10 scrolls information “F002,” which was indicated in display state t2, one digit at a time in the direction (left direction when segment display unit 10 in FIG. 2 is seen from the front), which is opposite that indicated by operation button 13 in FIG. 2, as was the case in FIG. 7B. At the same time, the next information “192” is scrolled one digit at a time in the above-mentioned left direction and is displayed.

Next, when operation button 15 (−X direction) is pressed in display state t3 which displays information “192” in FIG. 12, display control unit 27 reads information “F002” allocated to cell (X,Y)=(1,2) from display information table 160 and displays it in segment display unit 10. At this time, segment display unit 10 scrolls information “192” displayed in display state t3 in FIG. 12 one digit at a time in the direction (the right direction when segment display unit 10 in FIG. 2 is seen from the front) opposite that indicated by operation button 15 in FIG. 2, as indicated in display state t21 in FIG. 13B. At the same time, the next information “192” is scrolled one digit at a time in the above-mentioned right direction and is displayed.

Next, when operation button 12 (+Y direction) is again pressed in display state t4, which indicates information “F002” in FIG. 12, like FIG. 7A, segment display unit 10 scrolls information “F002” displayed in display state t4 segment by segment in the direction (upward direction when segment display unit 10 in FIG. 2 is seen from the front) opposite that indicated by operation button 12 in FIG. 2, as was the case in FIG. 7A. At the same time, the next information “F003” is scrolled segment by segment in the above-mentioned upward direction and is displayed.

When the segment display device in Embodiment 2 is used, information selected from a plurality of types of information can be easily presented to the user, in the same way as with the segment display device in Embodiment 1.

Also, when the segment display device in Embodiment 2 is used, information displayed in segments can be moved not only in the +X direction and the +Y direction in the data space in the display information table but also in the −X direction and the −Y direction, thereby improving its usefulness to the user. For example, when a great deal of information is displayed, information located at the back can be displayed quickly, and the time it takes to display the desired information can be shortened.

Also, like the segment display device in Embodiment 1, when display information is switched in accordance with operations input to operation buttons 12 through 15, the display information is scrolled and switched as indicated above so that a likeness wherein viewing window 10A moves in the direction (±X direction and ±Y direction) indicated by operation buttons 12 through 15 in the above-mentioned data space 162 can be thoroughly grasped by the user so that the user can easily obtain the desired information.

The present invention made by the inventors was explained specifically above based on embodiments, but it should by no means be construed that the present invention is restricted to these examples and needless to say a number of variations are possible as long as they remain within the parameters of the invention.

For example, in the above-mentioned embodiments, operation buttons 12 through 15 were illustrated, however these are by no means restricted to the examples and operations that may be carried out using a touch sensor among others.

In the embodiments given above, the segment display device in the present invention was illustrated with 4 digits of display area, however, the invention is by no means restricted to this. For example, a display area may consist of one digit, two digits or three digits. In addition, while the segment display device in the above-mentioned practical examples featured a seven-segment display, it is by no means restricted to this and an eight-segment display and a fourteen-segment display which can display decimal points may also be used.

In addition, the above-mentioned embodiments illustrated application of the segment display device in Embodiments 1 and 2 to a data server and a controller. However, it may also be applied to other devices with a segment display device.

In the embodiments given above, a configuration with address calculation and processing units 170, 270 and information read unit 171 was cited as a specific configuration for display control units 17, 27. However, these were just examples and another configuration can be used as long as information displayed in segment display unit 10 can be switched in sequence in the row and column directions of display information table 160 in accordance with operation detection signals from operation buttons 12 through 15.

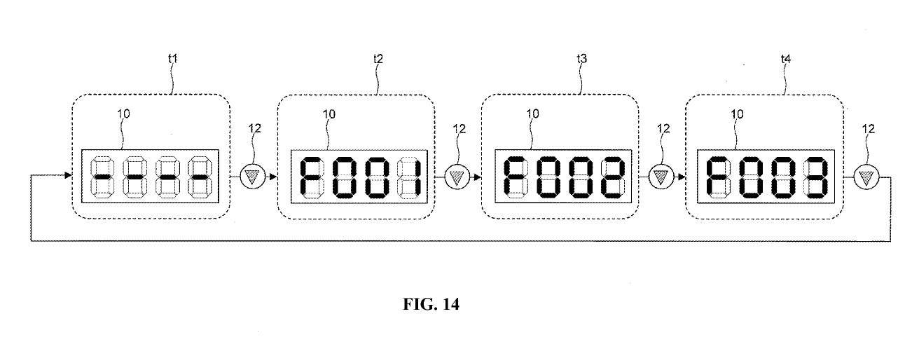

Also, in the embodiments given above, information “F001” in cell (X,Y)=(1,1) was given as the initial display for segment display unit 10. However the invention is by no means restricted to this, and initial display information can be displayed as the initial display state. For example, when display information table 160 consists of 3 rows×3 columns (m=n=3), the initial display information (for example, “ . . . ”) is set beforehand, as indicated in FIG. 14, and the initial display information is displayed to segment display unit 10 first. In that state, when operation button 12 is pressed, information “F001” in cell (X,Y)=(1,1) is displayed; then, when operation button 12 is pressed, information “F002” in cell (X,Y)=(1,2) is displayed. Also, when operation button 12 is pressed in a state which displays information in the cell which is in the last row in column number X =1 (for example, information “F003” in FIG. 14), initial display information “ . . . ” is again displayed. Thus, switching the display of segment display unit 10 may be carried out using the initial display information as a starting point.

### EXPLANATION OF REFERENCE NUMERALS

1, 5 . . . segment display device,
2 . . . data server,
3_1-3n . . . controllers,
4 . . . network,
10 . . . segment display unit,
11 . . . display area,
12˜15 . . . operation button,
16 . . . storage unit,
160 . . . display information table,
161 . . . cell,
17, 27 . . . display control unit,
170, 270 . . . address calculation and processing unit,
171 . . . information read unit,
18 . . . display information.

1. A segment display device comprising:
a first operation input unit and a second operation input unit configured to input operations from an outside environment;
a segment display unit configured to display information in a segment format;
a storage unit configured to store information which can be displayed in the segment display unit by mapping into a display information table comprised of a plurality of cells comprising a plurality of rows and columns; and
a display control unit configured to read information mapped in the plurality of cells from the storage unit, and display the information in the segment display unit;
wherein, every time an operation is input to the first operation input unit, the display control unit is configured to select information mapped in each cell in the display information table in order in a first direction along a column in the display information table and displays the information mapped in each cell in the segment display unit; and
wherein, at the same time, every time an operation is input to the second operation input unit, information mapped in each cell of the display information table is selected in order along a row in the display information table and displayed to the segment display unit.

2. The segment display device of claim 1, wherein at a time when an operation is input to the first operation input unit, the segment display unit is configured to scroll information displayed at that time segment by segment in a direction opposite a direction indicated by the first operation input unit; at the same time, the information to be displayed next is scrolled segment by segment in the direction opposite the direction indicated by the first operation input unit and displayed so that the information to be displayed is switched.

3. The segment display device of claim 1, wherein the segment display unit further comprises a display area having a plurality of digits which is configured to display information in a segment format;
wherein, at a time when an operation is input to the second operation input unit, the segment display unit is configured to scroll information displayed at that time one digit at a time in a direction that is opposite a direction indicated by the second operation input unit and at the same time, the information to be displayed next is scrolled one digit at a time in the direction opposite the direction indicated by the second operation input unit and is displayed so that the information to be displayed is switched.

4. The segment display device of claim 1, wherein an operation is input to the first operation unit at the time that there is information mapped in a cell corresponding to a last row in the first direction in a single column in the display information table, the display control unit is configured to display information mapped in a cell corresponding to a first row in the first direction in the column in the segment display unit.

5. The segment display device of claim 1, wherein an operation is input to the second operation input unit at the time that there is information mapped in a cell corresponding to a last column in the second direction in a single row in the display information table, the display control unit is configured to display information mapped in a cell corresponding to the first column in a second direction in the single row in the segment display unit.

6. The segment display device of claim 1, further comprising a third operation input unit and a fourth operation input unit configured to input operations from the outside environment such that every time an operation is input to the third operation input unit, the display control unit selects in sequence information mapped to each cell in the display information table in direction that is opposite the first direction in the display information table and displays it in the segment display unit; at the same time, when an operation is input to the fourth operation input unit, information mapped to each cell in the display information table is selected in order in a direction opposite that of the second direction in the display information table and is displayed to the segment display unit.

7. The segment display device of claim 6, wherein at a time when an operation is input to the third operation input unit, the segment display unit scrolls segment by segment information displayed at that time in a direction that is opposite a direction indicated by the third operation input unit; and wherein, at the same time, the information to be displayed next is scrolled segment by segment in a direction opposite a direction indicated by the third operation input unit and displayed so that the information to be displayed is switched.

8. The segment display device of claim 6, wherein the segment display unit comprises a display area having a plurality of digits which are configured to display information in a segment format;
and wherein when an operation is input to the fourth operation input unit, the segment display unit scrolls the information displayed at that time one digit at a time in the direction opposite a direction indicated by the fourth operation input unit and wherein, at the same time, information to be displayed next is scrolled one digit at a time in the direction opposite the direction indicated by the fourth operation input unit and is displayed so that the information to be displayed is switched.
